(19) United States
(12) Patent Application Publication
(10) Pub. No.: US 2002/0040313 A1
(43) Pub. Date: Apr. 4, 2002

(54) System and method of real time deployment

(76) Inventors: David Scott Hunter, Clermont, FL (US); Gregory A. Rose, Orlando, FL (US); Joe Schott, Clermont, FL (US); Timothy Sypko, Ocoee, FL (US)

Correspondence Address: OPPENHEIMER WOLFF & DONNELLY LLP, 38th Floor, 2029 Century Park East, Los Angeles, CA, 90067-3024, US

(21) Appl. No.: 09/947,259

(22) Filed: Sep. 5, 2001

Related U.S. Application Data
(60) Provisional application No. 60/230,036, filed on Sep. 5, 2000.

(51) Int. Cl. G06F 17/60

(52) U.S. Cl. 705/9

(57) ABSTRACT

A computer based system for the real time deployment of a plurality of individual human resource units (employees) that does not require the constant attention of a supervising staff member. Employees interact with input devices at their work location throughout the day to receive their assignments, breaks, lunches, and other information. Managers make scheduling and deployment decisions within the system and are provided with information as to how these changes will impact the day's operation.

### RELATED APPLICATIONS

This application relates to U.S. Provisional Patent Application No. 60/230,036 filed Sep. 5, 2000, entitled Cast Deployment System, and U.S. Provisional Patent Application No. 60/230,82 filed Sep. 5, 2000, entitled Location Level Forecasting and U.S. patent application Ser. No. ______ (Attorney Docket 20433-13) entitled Automated System and Method of Forecasting Demand, filed contemporaneously with this application, the contents of which are incorporated herein.

### BACKGROUND OF THE INVENTION

1. Field of the Invention

The invention is related to human resource allocation and deployment. More particularly the invention relates to managing work schedules and rest periods for groups of human resource units dispersed throughout a large diverse work area.

2. General Background and State of the Art

Amusement parks have a large number of employees to administer at any given time, with a large and diverse work area, within which may exist many operating areas which do different things. Since each operating area has its own unique characteristics, effectively coordinating the management of such geographically dispersed operating areas is a challenging task. Sudden changes in visitor patterns or volume may not always be foreseen, and it may be necessary to shift and share resources between operating areas depending on the real time need of each area. In doing this, there are several variables to be considered, such as differences in skill level amongst employees, etc. Since even the slightest inefficiencies can mean millions of dollars to large operations, effective management is a key to successful operation.

Under current and previous methods of management, a dedicated human resource, such as a coordinator or manager, is used to effectively accomplish the task of position assignment and break or lunch allocation at each operating area throughout the park. This method of management was effectively a paper method; the manager keeps a list of the employee's names for who they are responsible as well as the breaks assigned to them. The manager is responsible for determining which people to break and when. When it is time for an employee's break, the manager notifies that person and crosses them off the list. This method requires a huge amount of human interaction and makes it hard to determine where operating areas stand throughout the day. An excessive amount of time managing the breaking processes of park employees is wasted by dedicating a person to do such a job. Managers must also be trained to be consistent with the company's standards. The prior art paper methods turn out to be quite inefficient and thereby costly.

Other approaches have been to adopt a rotation of positions which “self manage” themselves. Although this approach requires less attention from an on-site manager, the inefficiencies are much greater. Therefore, as a result of such problems in effectively managing large dispersed groups of employees, a method of improving the way human resources are deployed is desired.

### SUMMARY OF THE INVENTION

Accordingly, the present invention provides a computer based system and method for the real time deployment of a plurality of individual human resource units, or employees, that does not require the constant attention of a supervising staff member. Employees interact with input devices at their work location throughout the day to receive their assignments, breaks, lunches, and other information. Frontline leaders or managers make scheduling and deployment decisions within the system and are provided with information as to how these changes will impact the day's operation. The system utilizes an automated process to update and track employee positions worked continually throughout the day. The present invention utilizes several methodologies in deploying employees to positions within an operating area for which they are trained. The present invention performs useful functions such as assigning breaks and lunches to employees based on shift length and displaying all such activities to the manager on duty, indicating when breaks and lunches are late or are not being taken. It allows the manager to rank all positions for the day in priority order and fills open positions with employees in that order as they sign in for the day. The present invention allows the manager to make real-time changes to employees' deployment schedules, for example; extend the work day, release employees early, and automatically recognize staff overages in deployment and assign employees to utility positions. The present invention also facilitates communication by allowing the manager to send messages to the employees in their deployment area.

The use of a computer based tool allows managers to better utilize labor and plan for the day's operation than previous paper methods. Accordingly, the present invention obviates the above mentioned drawbacks of the prior art systems and provides a system and method for the real time deployment of individual human resource units by character and need. This system provides leaders with a better view of labor as it compares to work needed. Some key advantages of this system include the equitable distribution of assignments and reduced labor management errors. The system allows managers' visibility to all aspects of their deployment area, i.e., workload, activity queue, bulletin board, shift management and allows them to make adjustments as the business needs change throughout the day.

The present invention provides additional benefits as well. A more organized work schedule with more timely breaks results in a happier workforce, which in turn results in an overall improved guest or customer experience. Managers now have improved tools to manage their business better. For employees, the system benefits include improved communication, potential increased job variety and productivity, and more equitable distribution of breaks and lunches. Employees are now deployed more consistently, driving satisfaction. The automated deployment system will enable managers to spend more time with employees and allow them to dedicate time working on more beneficial efforts.

The present invention estimates considerable savings for those locations at which the application will be implemented. The invention may be used for park attractions, food & beverage operations, merchandise and general operations locations. Other objects, features, and advantages of the present invention will become apparent to those skilled in the art from a consideration of the following detailed description taken in conjunction with the accompanying drawings which illustrate, by way of example, the principles of the present invention in the context of an exemplary system and method for the real time deployment of human resources.

### BRIEF DESCRIPTION OF THE DRAWINGS

FIG. 1 is a block schematic diagram of an exemplary embodiment of the deployment system of the present invention.

FIG. 2 is a block schematic diagram of an exemplary embodiment of the functions available to an employee as a part of the deployment system according to the present invention.

FIGS. 3a and 3b are screen shots of an exemplary embodiment of the employee welcome screen.

FIG. 4 is a screen shot of an exemplary embodiment of the employee schedule information screen.

FIG. 5 is a block schematic diagram of the functions available to a manager as a part of the deployment system according to the present invention.

FIG. 6 is a screen shot of an exemplary embodiment of the manager welcome screen.

FIG. 7 is a screen shot of an exemplary embodiment of the manager position maintenance screen.

FIGS. 8a and 8b is a screen shot of an exemplary embodiment of the deployment group maintenance screen.

FIG. 9 is a screen shot of an exemplary embodiment of the task type maintenance screen.

FIG. 10 is a screen shot of an exemplary embodiment of the daily labor report screen.

### DETAILED DESCRIPTION OF THE EXEMPLARY EMBODIMENTS

The present invention provides an improved computer networked system for the real time deployment of a plurality of individual human resource units by character and need. Referring more particularly to the drawings, an exemplary embodiment produced in accordance with the teachings of the present invention is illustrated in FIG. 1. For purposes of explanation and without limiting the scope of the present invention, the exemplary deployment system is illustrated to demonstrate the unique features of the present invention in a simple context.

FIG. 1 displays a schematic of the deployment system. At least one central processor 100 is present. Central processor 100 is generally a part of a computer or server. Processor 100 receives data and instructions entered from a plurality of input devices 102. Each input device 102 is located within a deployment or operating area 104 with its own unique characteristics. Input device 102 communicates with processor 100 and database 106 to retrieve information stored in database 106. Information can also be inserted or updated in database 106 through interaction with input device 102. A computer network 108 facilitates the communication between processor 100, database 106, and plurality of input devices 102. The computer network may be any kind of communications network; but preferably the network is one or a combination of Ethernet, optical, and wireless. Input devices 102 are currently desktop computers. It should be noted, however, that the invention should not be limited to desktop computers; any input device may be used to effectively communicate with the server. It is anticipated that other embodiments of the present invention may utilize newly emerged wireless devices in addition to or in place of a desktop computer as input device 102. For example, this may include wireless devices such as one or two-way pagers, personal digital assistants (PDA), wireless phones. Employees and managers working within each deployment area login to the deployment system at the beginning of each work day, and at various times throughout their day through input device 102.

The deployment system and method of the present invention receives data from two main sources. The first is data from a forecasting system. The forecasting system is a computer system designed to predict visitor attendance and translate this data into projected workload for an operating area. The second main source of data is from a scheduling system. The scheduling system receives projected workload data from the forecasting system and creates schedules for employees based on the forecast. The schedules are usually determined two to three weeks ahead of time by the forecasting and scheduling systems. Since things always come up, for example employees call in sick or request changes to their schedule, the deployment system is used to adjust for such changes. A third source of data is additionally from an employee database which contains information about the employees.

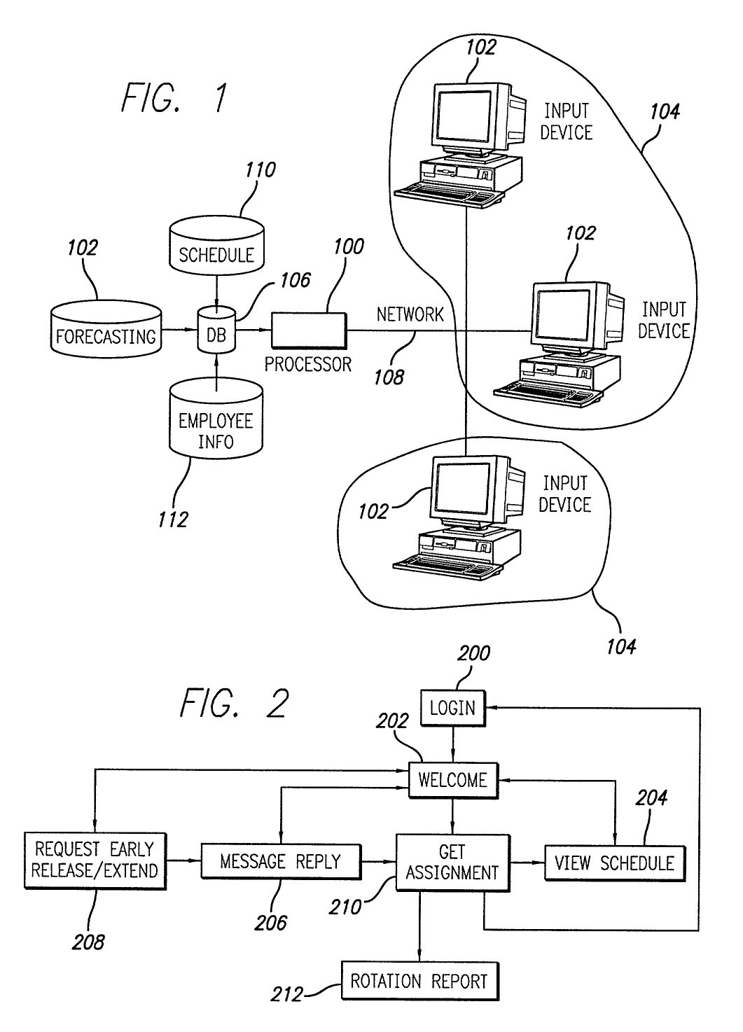

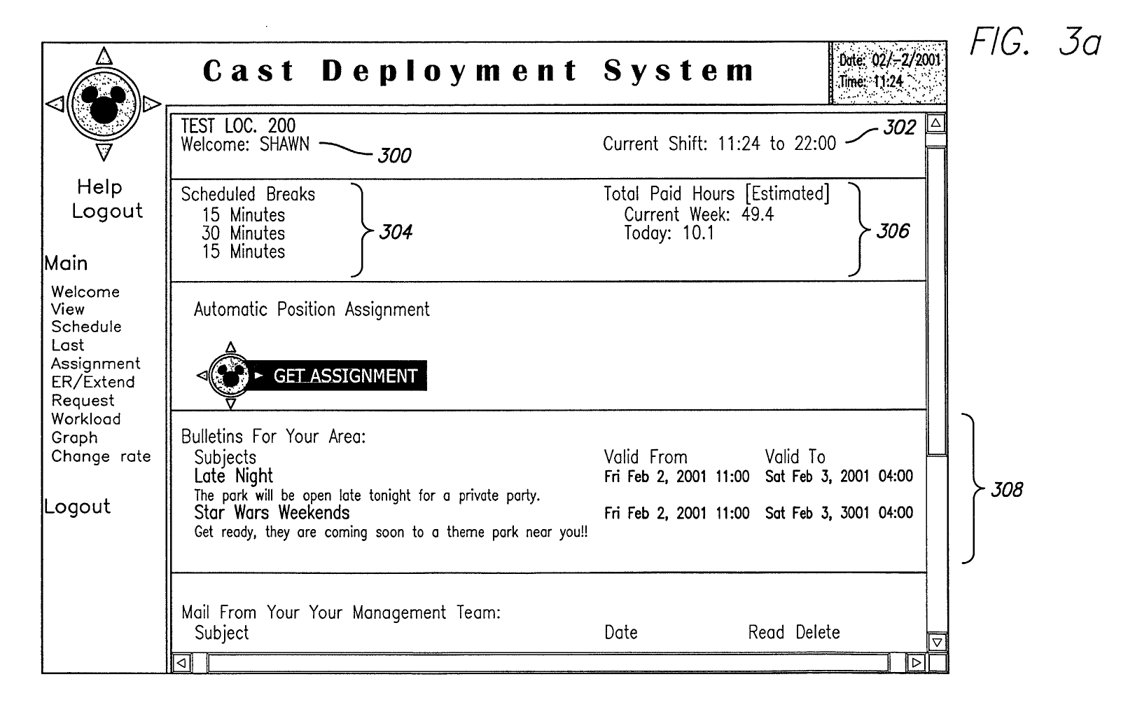

The system can be further explained by division into three sets of functions: those any employee or human resource unit can perform, those a manager or trainer can perform, and those functions reserved for system administrators. FIG. 2 is a block schematic diagram showing the functions that may be performed by any employee or human resource unit with access to the deployment system. A client session begins with block 200, when a human resource unit logs onto the deployment system using a local input device connected to a communications network. The local input device may be a desktop computer, or similar, with keyboard and monitor, or other means by which a person may log in to the deployment system as mentioned above. The deployment system requires at least some sort of user ID to enter the system. In an exemplary embodiment of the present invention, the employee's social security number is used as the user ID. If the employee role is limited to only that of an employee with no management or training responsibilities, no further security will be required to enter the system. Alternative embodiments of the invention may include additional security such as the use of a password, however it is not considered necessary. Alternative embodiments may also use other means of authentication, including other forms of user name/password, swipe cards, voice recognition, or keystroke identification. The user ID is validated against the deployment system id number as found in the deployment system database. If the ID does not exist, the employee will not be allowed access into the system. If the ID does exist, further checks may be performed; for example, to ensure that the employee is active or that the employee is authorized to access the system from that location. If the employee is not active, he/she will not be allowed access into the deployment system. If the checks are successful, he/she will be allowed access into the deployment system and greeted with a welcome screen. Once the employee has successfully logged into the deployment system, there a several important functions available to them. Block 204 show that they employee may view his schedule from the main screen. An employee may also reply to messages from the manager on duty as shown at block 206, or request an early release or extended shift as shown at block 208. The main functionality of the welcome screen, however is for the employee to get their next assignment, which is shown at block 210. Once an employee receives his next assignment, block 212 shows that a rotation report detailing any changes in other employee assignments may optionally be printed for the employee to take away.

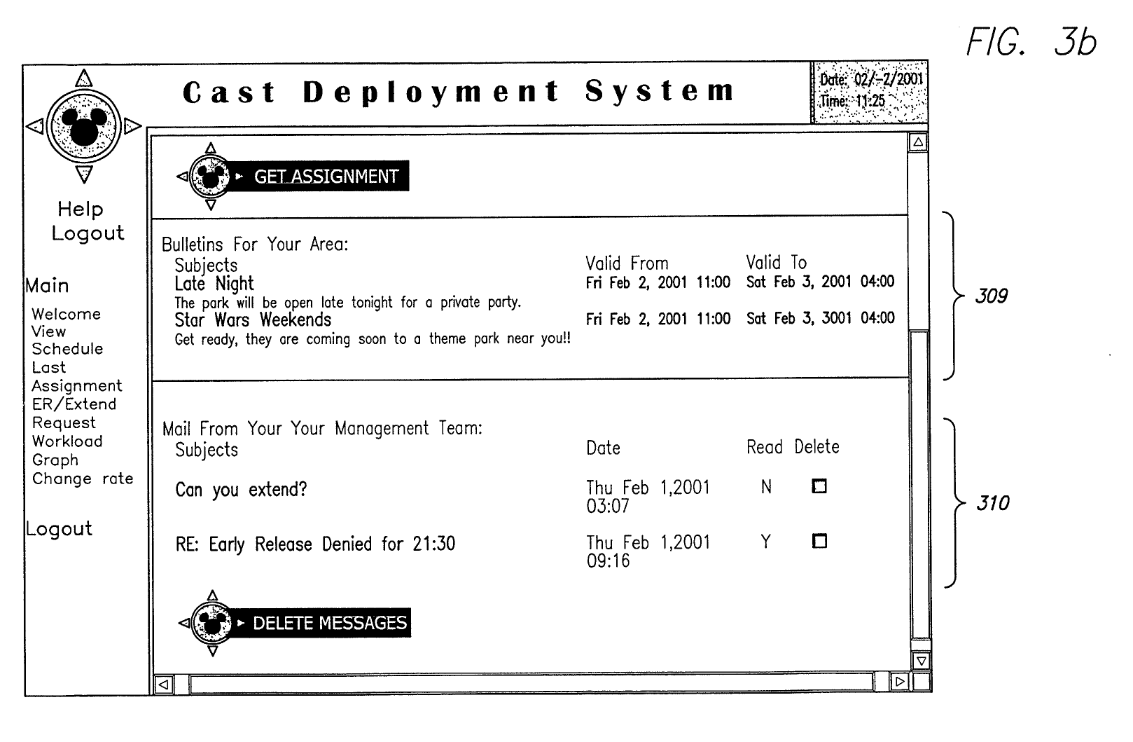

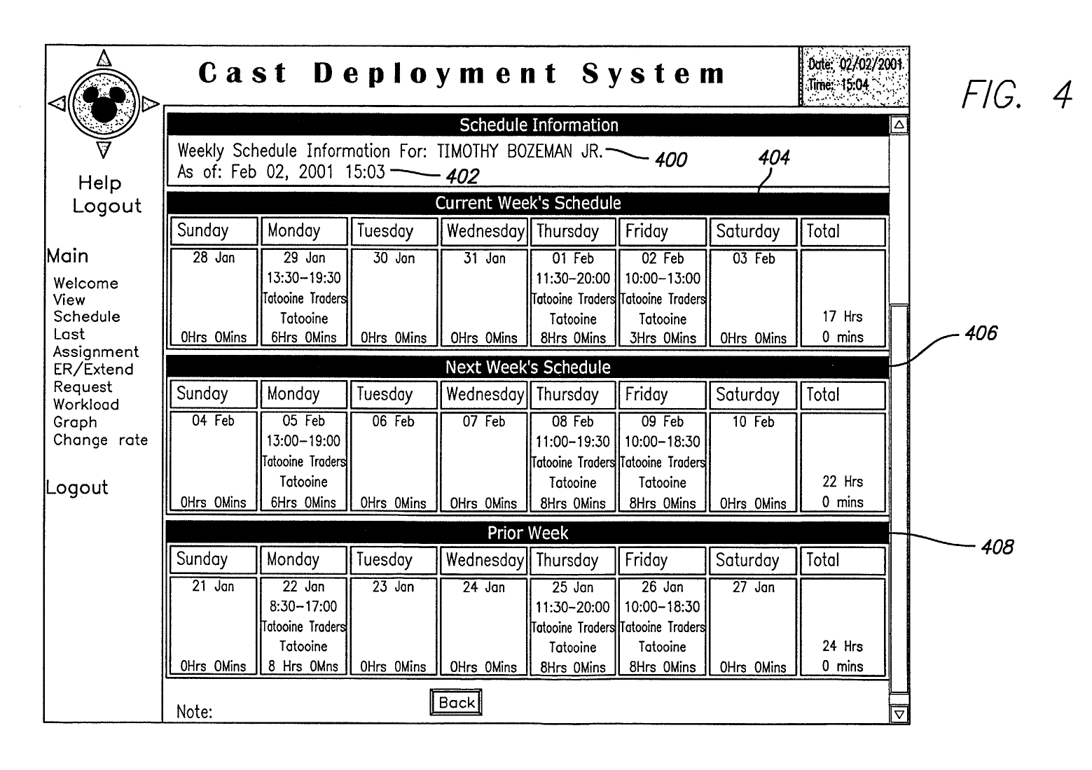

An exemplary embodiment of the graphical user interface of the main employee welcome screen is shown in FIGS. 3a and 3b. Exemplary embodiments of the present invention employ a web browser as the primary user interface to the application. As shown in FIGS. 3a and 3b, the main layout of all the browser screens in this particular embodiment of the deployment system consist of two “frames”; the left frame is for navigation purposes and contains links to options available to the user from that screen, and the larger, right frame contains the relevant information intended for the user. Referring now to FIG. 3a, the welcome screen displays the employee's name 300 and current shift time 302 at the top of the screen where it is easily viewed. From this screen, employees can review their breaks for the day 304, view their total estimated pay hours for the day and week 306, select and receive assignments, review general area wide bulletins 308, and review and respond to mail from the manager on duty 310. Scheduled breaks for the day 304 are listed in plain view, as well as total paid hours 306. This information is populated from the deployment system database, whose design includes tables that contain employee records, detailing such information. If it is the beginning of the day and the employee has not already been assigned a position, the deployment system will query the database to generate a startup list, which allows an employee to select their first position for the day.

By choosing the “Get Next assignment” button 314, the deployment system requests the next available position for which the employee is qualified. In order to assign a position however, a number of criteria must to met first. The systems will first determine if the employee is currently assigned to a position, or if the employee has been assigned a task with a required percentage of completion and the necessary percentage of completion has elapsed. The employee must not be assigned a permanent position, or have another task already assigned to them in the activity queue. There should not be any overdue tasks in the activity queue for the employee. Once an assignment has been selected and confirmed, the system prints out details of the employee's schedule for the day, the employee may log out of the deployment system, and proceed to their work assignment. In another embodiment of the present invention, available positions are displayed in a drop down list. Only those positions which the employee is allowed to perform appear in the list. The employee may choose a position from the list and confirm the assignment. If appropriate, the invention may prompt the employee for more details such as a desired length of time for the shift selected. If no position is available, an error message will appear prompting the employee with instructions, perhaps to see their supervisor.

From the main welcome screen, an employee can also easily read and reply to mail messages as shown at block 206 of FIG. 2. This screen displays all messages that have not been read or responded to. In one embodiment of the present invention, the user can open a mail message and respond with a pre-defined list of choices. Users are not allowed to enter free-form text or comments in response to the manager on duty, or to initiate a mail message, in this particular embodiment of the present invention. Other embodiments may allow the user to more freely compose and respond to mail messages, however.

Another feature of the present invention is the ability for the employee to view his/her schedule easily. An exemplary embodiment of the schedule information screen of the present invention is shown in FIG. 4. Here, a user can choose to view their schedule for the prior week, the current week, and the next scheduled week, if provided. The employee name is shown at 400 along with the current date and time at 402. The deployment system queries the database tables containing shift information using variables such as date and location, and returns all records matching the employee's ID, then populates the screen with the employee's schedule information in an organized calendar format. In this exemplary embodiment of the schedule information screen, the employee's current week schedule is shown at the top of the screen at 404, next week's schedule is shown at 406 directly underneath, and the prior week's schedule is shown at 408 at the bottom of the page. In some embodiments of the present invention, the user can view their schedule for all locations worked, not just the current location's schedule.

The present invention also provides an improved method for employees to request an extension to their shift or ask for early release from their shift. In one embodiment, the user is prompted to select from a predefined drop down list of reasons as well as the time requested for extension or early release. Submitting a request sends a message to the manager on duty, which will appear in the manager's list of unread messages. The manager will have the opportunity to approve or decline the request. The response will be sent back to the requesting employee as a message on the employee welcome screen. The deployment system then makes the appropriate changes to the deployment area's schedules based on the extension or early release of the employee's shift.

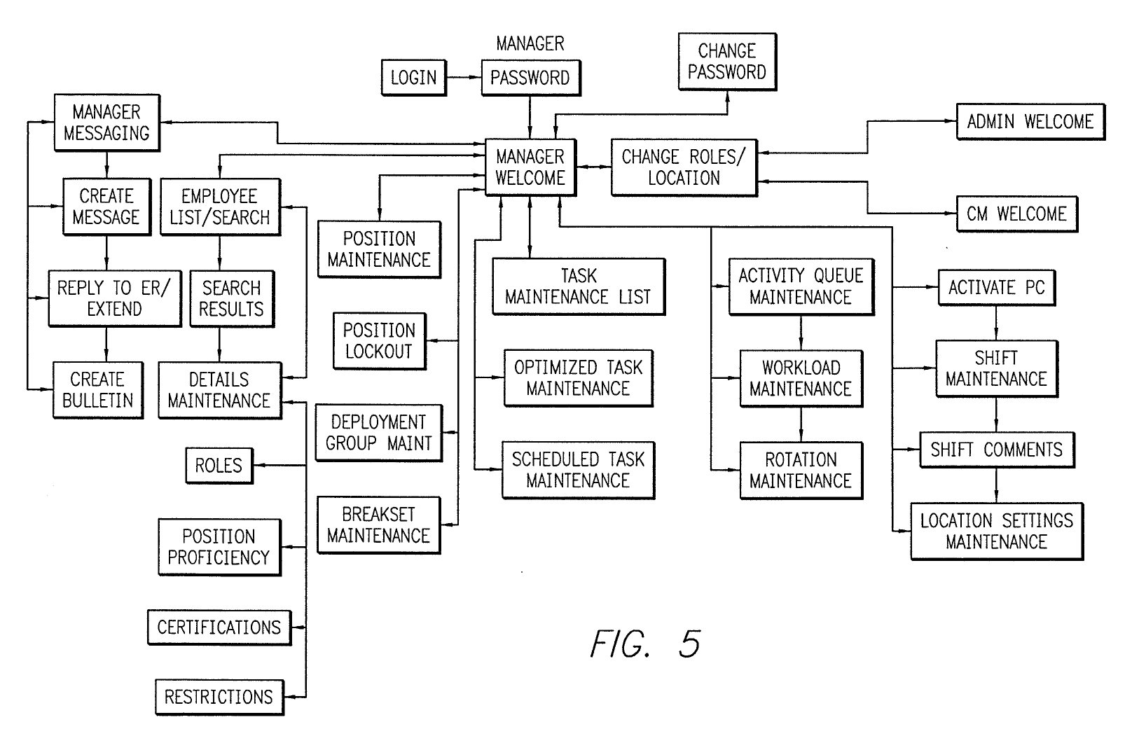

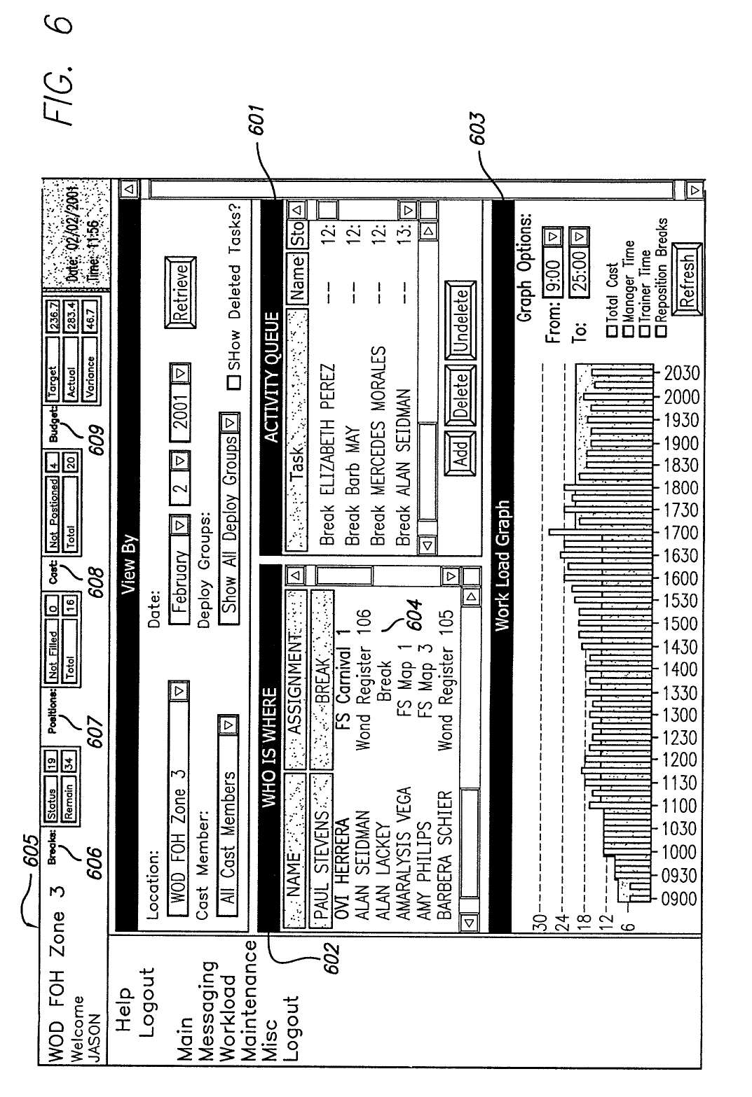

Referring now to FIG. 5, the functions available to that of a manager or training role are detailed in the block schematic. As detailed above, the logon process 22 is the same for managers and employees, except that a password is required in addition to the user id for managers login. The password is protected as it is entered on the screen, and if a match isn't found, an error message will prompt the employee to reenter their id and password again. Upon successful entry into the deployment system, managers are redirected to the manager welcome screen 502. From screen 502, the manager has the option to do many things, including sending and receiving messages to/from their deployment area, performing searches on employees, viewing and making changes to employee positions, or the activity queue, etc.

The main screen presented to a manager at login is intended to display all the pertinent information the manager requires for the chosen business operation area at a glance upon entry into the deployment system. The main welcome screen allows for simultaneous viewing of the who Is where, activity queue and workload graph screens. A preferred embodiment of this screen as defined by the present invention is show in FIG. 6. The screen displays the current status of breaks, how many positions remain unfilled, how many employees remain unpositioned, as well as information about the budget, across the top of the screen which can be accessed quickly and easily. The activity queue 601, deployment queue 602, and workload graph for the day 603 are also displayed on the main manager screen. Activity queue 601 is a list of the assignments scheduled for a workday. The activity queue list displays a prioritized list of tasks waiting to be assigned. A manager can adjust the times when assignments occur and delete assignments from the queue. Deployment list 602 displays all employees who are currently assigned to tasks, and which tasks they are assigned. By selecting an assignment 64 from the list, the manager can edit the time range, drop the position or task, bump the employee off the clock, or reassign the position or task to another employee. Workload graph 603 displays in a graphical format the variance between scheduled workload and the number of employees that have been deployed. If left open, the screen will refresh on a periodic basis. A status bar 605 is located at the top of each screen in an exemplary embodiment of the deployment system. The breaks portion of the status bar at 606 allows a manager to ensure that breaks are being given as scheduled. Status shows the number of minutes ahead or behind schedule the breaks are running. Remain allows a manager to see how many breaks are remaining in the day. Positions is shown at 607 and lets a manager quickly assess how many assignments have not been filled and how many assignments are currently scheduled. Cast, at 608, shows the total number of employees currently signed onto the deployment system. Cast also allows a manager to see how many of those employees are not currently assigned to a position. The Budget portion of the status bar shown at 609 allows a manager to see budgeted hours for that day. Target represents the target number of labor hours based on forecasting system predictions. Actual represents the number of labor hours that are actually scheduled for that day. Variance represents the difference between the target and actual number of labor hours. As seen on the left navigational frame, manager functions may be further categorized: messaging, workload, maintenance, and miscellaneous.

It is an important part of a manager's role to communicate with others. The present invention therefore provides a messages and bulletins section for the manager. All messages sent to the manager on duty are shown here. The messages/bulletins screen allows managers to check messages and compose bulletins and messages. Messages can be sent to one employee or multiple employees. Bulletins are sent to an entire area and can be displayed at specific times of the day. From this screen, the user can view all previously sent messages and bulletins. By highlighting or clicking on an individual message in the message list, the user can reply to this message. The manager can also create a new mail message or choose to delete existing mail messages. It should be noted that messages sent by employees are sent to the manager on duty, rather than to certain managers. This way, matters may be addressed more immediately, since there is always a manager on duty to read and respond to messages. Responding to messages that are requests for an early release or extension of shift will redirect the manager to the reply to early release/extend screen. Some embodiments of the present invention include a screen that allows managers to see which employees have requested an early release or extension and other details such as the employee's work status and comments.

Another key role of a manager in his/her daily work is managing the workload of staff. The manager must manage a the work schedule for a number of people, factoring in breaks for lunch or rest, as well as special circumstances in which someone may need to leave early that day. The manager must be able to match skill levels with positions or tasks as best as possible, and the manager must be able to adjust when guest demand changes. Therefore, the present invention provides a method in which the manager has the ability to maintain shifts easily. The present invention imports data from a labor scheduling system. Managers can modify the shifts, add new shifts, or delete shifts with the use of the present invention. If the shift being modified or deleted is in the current business day, the activity queue must be refreshed to reflect the changes. For instance, additional breaks may need to be scheduled if a shift is extended, or breaks and other tasks may need to be removed if a shift is shortened or deleted. The manager also has the ability to enter comments about an employee's shift, for instance, if the employee was late.

The system and method of the present invention further provides managers with the ability to easily perform maintenance on location settings, employees, positions, task types, etc.

Leaders or managers from each operating area must input additional local data and customize the system for their own unique operating needs. One thing that must be customized is the breaking methodology used in the operating area. Different operating areas have different characteristics which require different methods of management. The location settings screen allows the manager to determine the settings for their operating area. This screen allows the manager to enter and view information such as the number of minutes before an employee is considered late for their start of shift. For example, the minutes before late for start of shift is could be set for 6 minutes. If an employee signs in 5 minutes late, that employee will not be late in the system. If box 83 is checked, the manager is allowing employees to change roles when they need to. If the Allow Employees To View Workload Graph box 85 is checked, employees will be able to see the location's workload on their sign-in screen. Field 87 indicates how late a Employee must be to be required to see a manager before getting an assignment.

A list of all employees in the selected deployment area is displayed in the employee maintenance screen, and also allows the manager to perform a search of the entire database for an employee. Current embodiments of the present invention search by ID, last name, or first name. The list displays all employees who have been assigned work at the current deployment location with additional details such as their work status (full time, part time, intern, etc) and their seniority by start date. If a search is performed, the results will display the search results returned from the employee maintenance screen, or allow the manager to enter a new search. Each of the employees in the list generated may be selected, and further details viewed. Upon selecting a particular employee from the deployment area list or from a search result, the Details Maintenance screen allows the manager to view, add, or update employee information. The system looks up this employee's information in the appropriate employee databases. If the employee is found, any data that can be retrieved from the employee database will be retrieved. Changes or additions to an employee's details will be saved and the appropriate tables in the deployment system database updated. New employees may also be added easily to the system.

The Employee Maintenance Main screen allows managers to view all employees in a particular location, as well as their work status. The Employee Information Personal Data screen allows managers to view personal data downloaded from the employee database and add or change information such as “preferred language”. Information that is downloaded from the employee database will has a red asterisk next to it in one embodiment of the present invention, meaning that this information cannot be changed. However, if information is changed in the employee database, it will automatically be updated in the deployment system. To add a new employee to the deployment System, the manager clicks on button 91. The Employee Information Roles screen allows managers to identify which roles an employee will have at each location they work. The system default role will be what the system recognizes that individual as when they sign in. The selected roles will be what roles that individual can change to at any given time. For example, a trainer will default to an employee role but will have selected roles of employee and Trainer. The Employee Information proficiencies screen allows managers to select each Employee's proficiency in each role. For example, choices for proficiencies include None, Level 1, Level 2, and Level 3. Proficiencies allow the system to search for the most skilled Employees available to work individual positions. Finally, the Employee Information Certifications screen allows managers to view any certifications held by an employee.

It may be desired for special attention to be brought to a manager concerning certain employees. The present invention allows the manager to update an employee's record to note if they have special status, such as international, minor, under 16, in high school, etc. By applying special status, limitations of an employee's breaks, lunches or available work hours will be applied. The Special Status screen allows managers to assign a special status to an individual employee. Utilization of the Special Status screen ensures that managers are notified if there is a conflict with an employee's schedule and the limitations of their special status. It also may be necessary to restrict an employee to work in a particular deployment group or “perm” the employee to a specific position for a defined time and date range. The Restrictions screen allows managers to view and add any employee restrictions. The manager clicks on the Add Permanent Restriction button to add a permanent restriction from a deployment group or specific position. Click on the Add Date Range Restriction button to add a restriction that will only be in effect for a period of time.

It is also a useful feature for the manager to have the ability to define employee roles or positions. For example, a single person may perform different roles such as trainer or manager. In one deployment area, there may also be positions for cashier, greeter, ride operator, etc. All roles that the employee has for the current location should be displayed, and have the corresponding checkbox selected. Selecting a role will cause a record to be created in a table for this employee, Location, & Role combination. An option for position or role proficiency is also included where the manager may choose from a previously chosen set of rankings, or enter his/her own comments to describe the employee's ability to perform a certain role or work a position. For example, a proficiency level of 1 may be selected for the position of operator, and a proficiency level of 3 selected for a cashier to work during busy times. The Position Proficiencies option allows the Manager to select the positions and proficiencies for an individual employee. All Positions for this location should be listed. Different positions may have different selections for ranking the position, and the dropdown list for position proficiency for each position should be set the appropriate proficiency for this employee and position combination.

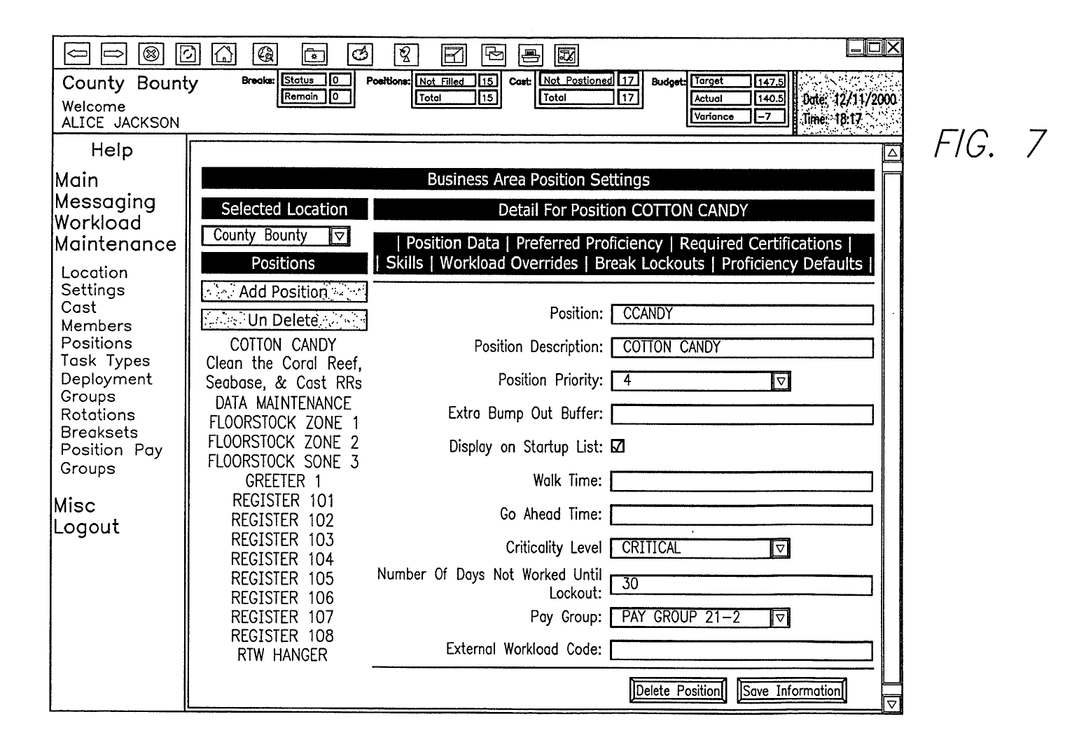

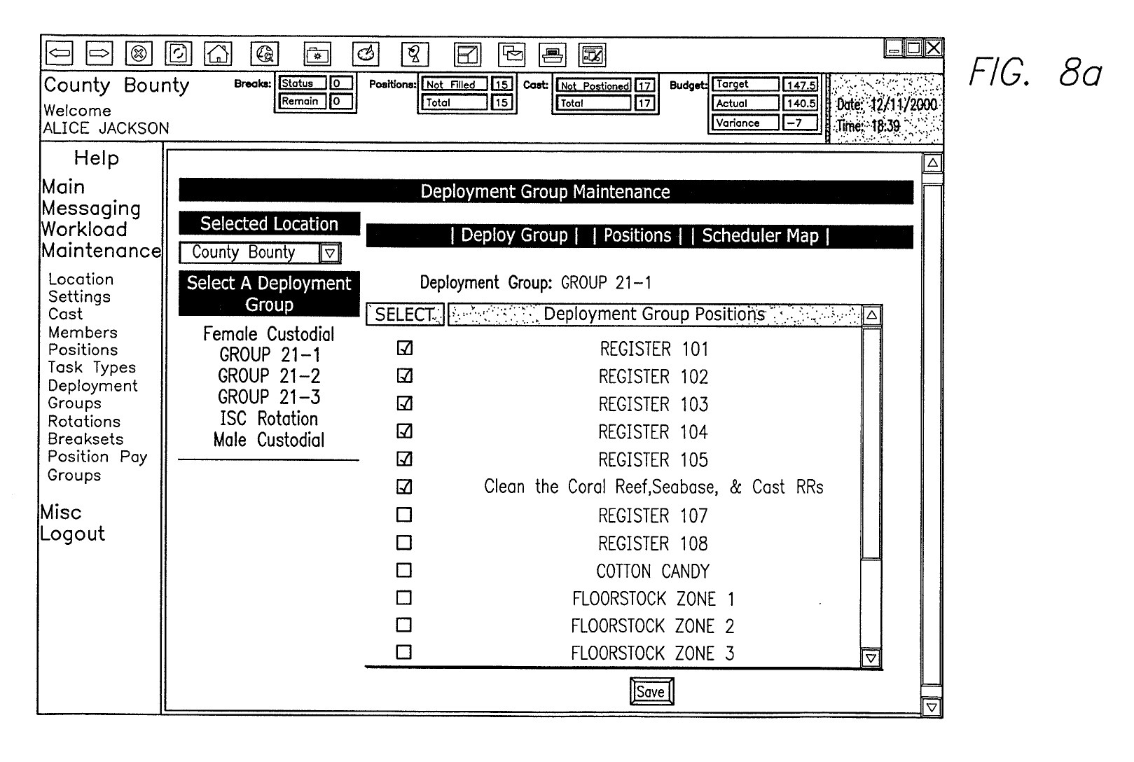

The position maintenance screen determine the parameters for various positions at an operating area or location. An exemplary embodiment is shown in FIG. 7. The position is the name by which the managers know the assignment. This is the name that will be on reports such as “Employee in Position”. The position description is the name by which the employees know the assignment. This name may or may not be the same as position. Position priority is used in instances when you have a workload/workload code that encompasses more than one position. In this situation, you must designate the order in which those positions go on line. Extra Bump Out Buffer allows managers to give a Employee additional time at the end of a shift to complete closing duties, such as banking out. Only one extra bump out buffer per position can be given to a Employee during a given shift. If management would like to allow Employees to choose their positions, Display on Startup List must be checked. Only positions in workload would be on this list. The Walk Time option allows management to specify the amount of time it takes to get from the deployment system terminal to a particular position. Transaction time should also be considered when setting the walk time. Go Ahead Time is the number of minutes before a scheduled task that a Employee can begin that particular position. This time is in addition to any go ahead time set up in the task type rules. The Criticality Level option allows management to determine which positions are most essential to run the operation. Choose from the following options: Critical—a position that is necessary to open a location. Non-Critical—a position that is not essential to the operation, but added as Employees become available. Variable—a position that is brought on line based on business demand. The Number of Days Not Worked Until Lockout option can be used to set a period of time after which a Employee must be retrained in a position. After the set time has expired, a Employee will not be deployed to this position. External Workload Code refers to the code by which a position is known in the forecasting system. The Pay Group field determines which location will be responsible for paying the hours for a particular position.

The Required Certifications screen allows managers to identify the certifications that are required in a particular position. An employee who does not have the required certifications for a position will not be deployed to that position. The Skills screen allows managers to identify the skills that an employee in a particular position must have. If an employee has a proficiency in a position, they will possess the skills for that position. This is used when running reports and queries. The workload override screen allows managers to override the forecasted labor hours for that position and add new up and down times. For example, although attendance may not change, an indoor food location may need additional positions during a rainstorm. The break lockout screen gives managers the option to designate a time frame in which employees will not be assigned breaks. This should only be used for short periods of time when business demand requires it, such as during a parade or during the lunch rush. The proficiency default screen allows managers to set the proficiency that a new employee will automatically have for a particular position. Each position has have a None, Level 1, Level 2, or Level 3 proficiency default.

The view general settings screen is where task parameters are set up and saved. Duration Percent can be set so a percentage of the scheduled task time must pass before a Employee may get another assignment. Go Ahead Time can be set to a period of time before a scheduled position start time, in which an employee may actually start that task. Priority will determine the order in which tasks are assigned. Task Action Phrase is the name by which the task is known to the Cast. Task Description is the name by which the task is known to management. The View Lockout Settings screen allows for the viewing and addition of time periods in which a task will not be assigned. The Add Task screen allows for the addition and setup of a task on the task list for the location.

The positions screen allows for the setup of positions within a deployment group. A deployment group is a group of positions deployed together within a location that align for business needs. Examples of this would be Food and Beverage Cashiers vs. Culinary. Each area will have a default deployment group as well as deployment groups made up of like positions. The default deployment group allows employees to be sent anywhere in a location regardless of the deployment group they are assigned, based on their proficiencies. There are positions for each deployment group. However, this screen allows for additional positions to be added to an existing deployment group based on business needs.

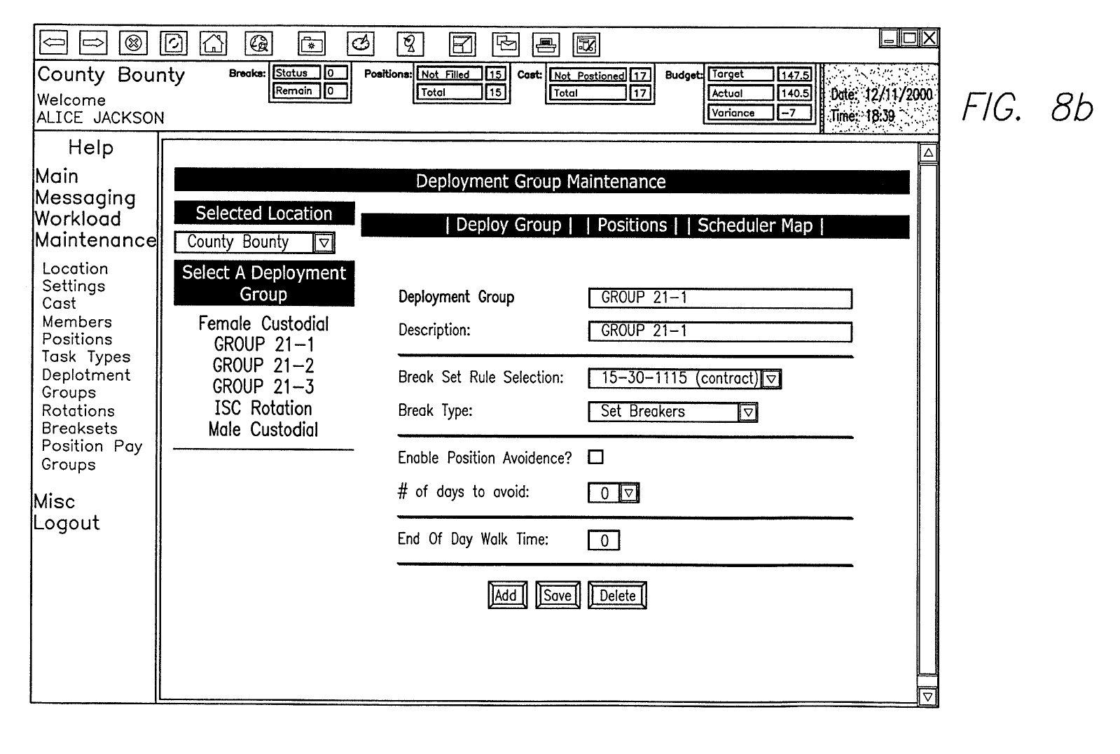

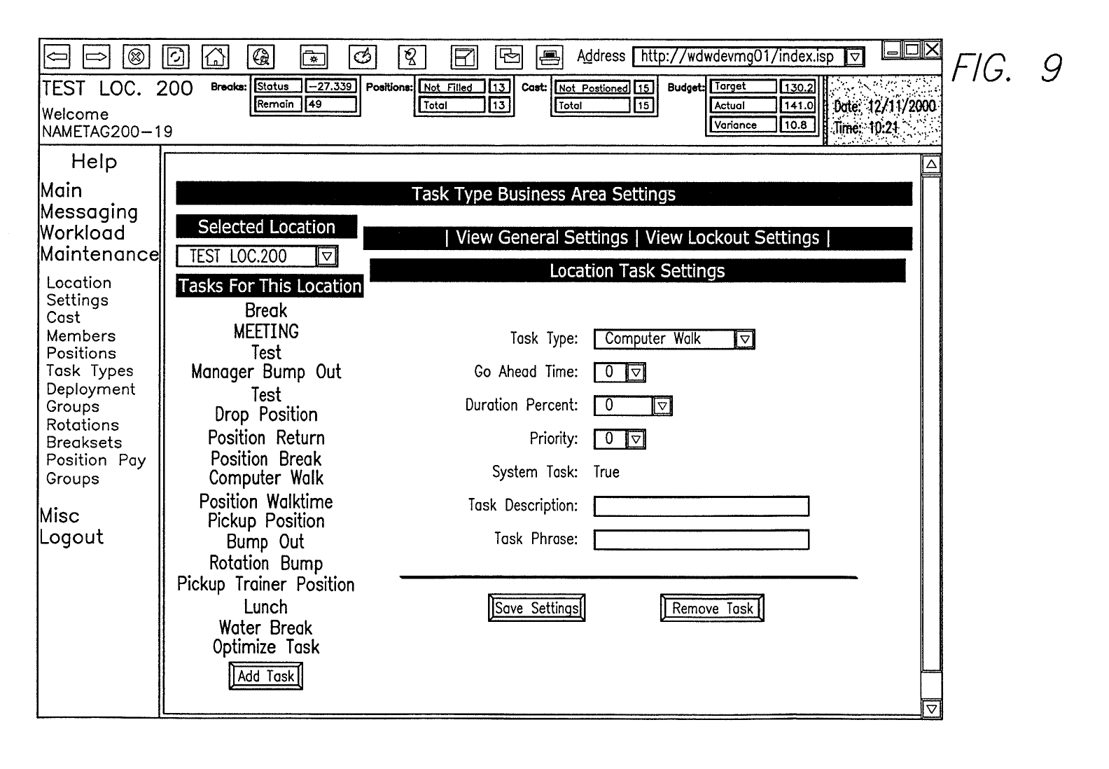

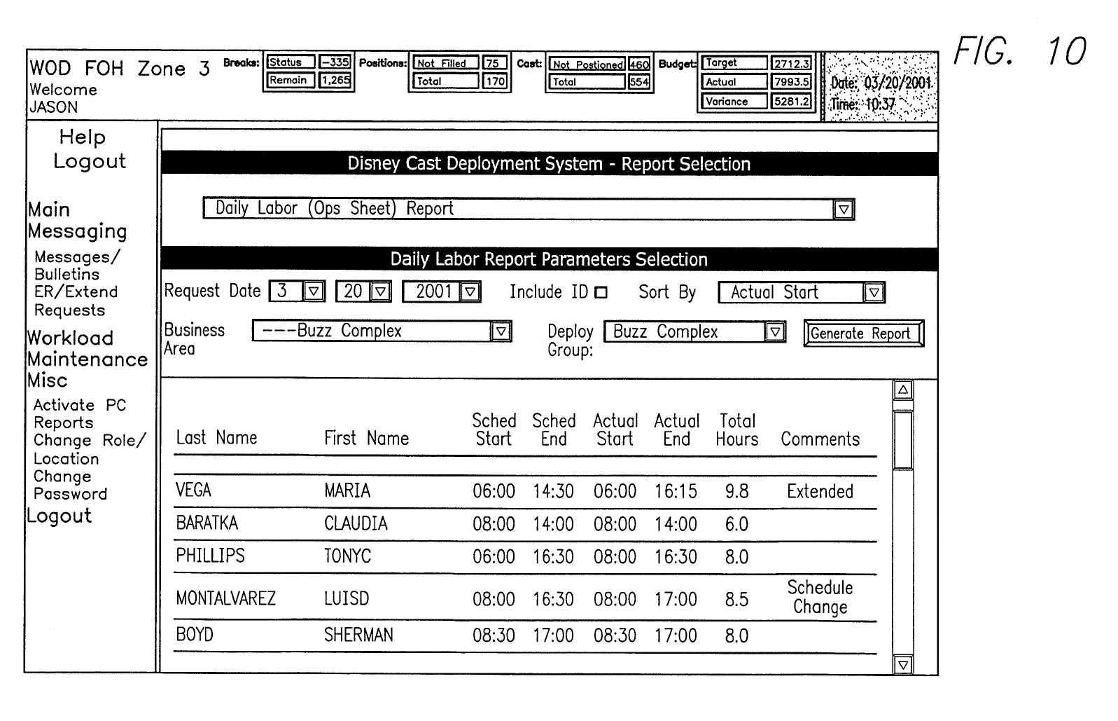

The deployment group maintenance screen allows for the setup of position avoidance, walk time and break-related rules within a particular deployment group. Exemplary embodiments of the deployment group maintenance screens are shown in FIGS. 8a and 8b. FIG. 8a shows how the manager can select from a plurality of positions to define each deployment group. The break set rule selection field of FIG. 8b allows for new and modified shifts to mirror the scheduling system. Break Type identifies how the employees in a deployment group will receive their breaks. For example, in one operating area it may make sense to have most employees work the same position throughout the day. In another operating area, it is more desirable for employees to have some variety in the positions they work throughout the day. The way in which each area is managed is different and requires different methods of managing positions, breaks etc. There are therefore several breaking methodologies utilized by the system and method of the present invention.

One methodology used by the present invention is the method wherein everyone is a breaker. A breaker is a member of an operating area that breaks employees working a position so that they can go to their break, lunch, or move to a new position. The breaker receives notification from the deployment system that they should break someone. In the Everyone's a Breaker methodology, the system assigns the next task that the employee can do having the highest priority; f they are able to work the next task then let them do so. 85% of locations use this method. Anyone can break anyone else, which means that all employees interact with the deployment system throughout the day.

Set breakers is another methodology used wherein a team is assigned to break employees. The team interacts with the deployment system and breaks the other employees in their group. Set Breaker functionality is a breaking type that allows managers to restrict the movement that occurs in the location relative to delivering breaks and lunches to employees. In areas that utilize Set Breaker functionality, employees typically return from break to the positions they left prior to the break. Set breakers should be utilized in locations where managers determine there is a need for an employee to return to his or her previous position after a break or lunch. For example, a location at which large sums of money would need to be transferred when employees go on break or go to another position might utilize Set Breakers as their breaking type. Set Breakers may be less efficient than other breaking types because additional movement takes place each time an employee comes back from break or lunch. Each location's employee movement will vary depending on the amount of peaks and valleys in the workload (positions picking up and dropping throughout the day), the workload fit, and other local issues. Another disadvantage of Set Breakers is that some employees may perceive that the individuals chosen as breakers are receiving preferential treatment. However, when managers devise a fair and consistent process for selecting Set Breakers and communicate that process to their employees, the perception of favoritism can be reduced.

There are two types of Set Breakers, system-assigned Set Breakers and manager-assigned Set Breakers. When system-assigned Set Breakers are utilized, the first Employee available when a break is due will be the Set Breaker until there is a position to be picked up. Manager-assigned Set Breakers follows the same basic rules, but gives the manager more control and reduces the amount of employees who move positions and receive assignments throughout the day. Manager-assigned Set Breakers means the manager selects who will be performing the breaker role. Employees selected as breakers remain breakers for the entire shift unless the manager updates the set breaker list. It allows managers to rotate all employees through the breaker role. It also allows the manager to assign opening employees to be breakers. System-assigned Set Breakers means that breakers are assigned by the deployment system. Employees selected as breakers remain breakers until there is a position to be filled. The deployment system will place employees into the breaker role based upon shift start time which may result in the same employees being the breaker day after day. The deployment system would generally not assign opening employees to be breakers.

Yet another breaking methodology used by the present invention is Self Breaker. In this method, each employee acts as his or her own breaker. In one situation of Self Breaker, the employee logs into the deployment system at the beginning of the day and doesn't return to the computer until the end of the day to log out. Generally this means the person has a permanent position all day long and there is no need to return to the computer throughout the day to check on assignments. In other situations of the Self Breaker method where employees do not have permanent positions, each employee returns to the computer throughout the day to receive their next assignment. In one version of self breaker the employee signs in get their first assignment and time for their first break. After taking their first assigned break, they return to the computer to receive their next assignment from the deployment system. In one embodiment, the employee is preferably returned back to same position if it is still needed. For example, in custodial positions there is often a feeling of ownership of the position and it is desirable to return employees to the same position. In another embodiment, the method is the same as the last but instead of the system returning the employee to the same position, the system assigns the next position of highest priority. For example, a merchandise stock person or salesperson may get bored of the same position all day long and it is desirable to have some variety and change positions throughout the day.

The rotation maintenance screen allows managers to view and change the positions and deployment groups within a rotation. This screen also allows for the setup of the rotation group parameters such as rotation method, frequency and rotation window. Full Loop and Straight Line rotations are available in the deployment system. The employee who starts a Full Loop rotation will return to the computer after the rotation, to get another assignment. The last person in a Straight Line rotation will go to the computer. Frequency refers to how often this rotation will be initiated. Duration refers to how long this rotation should take.

Another important feature of the present invention is the ability to easily produce reports detailing various aspects of the different deployment area's performance. A break trend report can be generated which displays information pertaining to employees and the scheduled vs. actual duration of breaks that they either took themselves or were responsible for sending other employees to break. The extend report provides a day-of list of employees who have requested an extension to their shift so that managers across property can identify available resources to fill positions that are understaffed. A list of locations that have an overstaffed condition during the current day based upon their workload and shifts within a user-specified time frame and hierarchy level can be generated to aid in pinpointing and eliminating excess labor. The budget report summarizes hours scheduled and hours worked against the target budgeted for a specified business date. It also provides other useful information regarding time worked during the day. The daily labor report provides a list of employees and their scheduled vs. actual shifts and paid hours. This report is used to communicate information to the employee time recording (ETR) clerks for clearing schedule vs. clocked exceptions. The late break report provides a list of employees whose actual break time occurred more than a certain number of minutes past their scheduled break time. The report can be generated based on any range of minutes. A list of employees who have worked a specified position during a specified date range can be listed in the employee position report. This report is useful in identifying employees that have received guest comments. The list of all positions that an employee has worked during a specified date range can also be generated with ease. More useful information would be to provide a list of positions and the last time an employee worked that position. The positions within a rotation report provides a list of positions within a rotation. The user can choose to display/print all positions within the rotation or only those positions that are being utilized today. The employee/manager schedules report provides a list of scheduled shifts from either the employee shifts or manager schedules tables for a selected date range. The request frequency report provides a list of extend/early release requests for the employees. The user can select a specific employee or all employees. The user can also specify a date range and whether to include extend requests only, early release requests only or both request types.

The third set of functions available in the deployment system are those performed by system administrators. Screen access is set up by the deployment system super-user. If an employee has a higher role than that of just an employee, the super-user might set up each individual screen that the employee has view, update, or delete access to. There is no standard security template assigned to each role level in the deployment system. Other tasks that are performed by the System Administrator include the creation of new departments, locations, and areas to creating and maintaining tasks, special status rules and skills to the creation of new role and permissions to the system. This level allows the system to drive consistency thought the users while providing them the customization that each area needs to be successful and productive.

Those skilled in the art will understand that the preceding exemplary embodiments of the present invention provide the foundation for numerous alternatives and modifications thereto. These other modifications are also within the scope of the present invention. Thus, by way of example, but not of limitation, the deployment system described, may be configured to function for businesses other than theme park settings. Such settings might include large retail stores which include several departments within, or employees with different training or skill sets. Accordingly, the present invention is not limited to that precisely as shown and described in the present invention.

We claim:

1. A method for the real time deployment of a plurality of individual human resource units by character and need, the method comprising the steps of:
a) maintaining a computer network dispersed throughout a diverse work area, the computer network having a central database and processor and a plurality of input devices at remote locations relevant to this diverse work area;
b) requiring at least one said human resource unit to log in to at least one of the plurality of said input devices; and
c) using the central processor to process input from said human resources units into said remote locations to generate a real time queue for actively deploying respective ones of said plurality of human resource units relevant to the location and needs of said work area.

2. The method of claim 1 further comprising the step of requiring at least one manager to log in to at least one of the plurality of said input devices.

3. The method of claim 2 further wherein said manager uses the deployment system to view employee information, positions, breaks, and overall schedule.

4. The method of claim 2 further wherein said manager uses the deployment system to compose mail to members of the deployment area, and view responses to mail.

5. The method of claim 2 further wherein said manager uses the deployment system to manage an activity queue.

6. The method of claim 2 further wherein said manager uses the deployment system view workload graph.

7. The method of claim 1 wherein said human resource units can review their breaks for the workday.

8. The method of claim 1 wherein said human resource units can review total estimated pay hours for the day/week

9. The method of claim 1 wherein said human resource units can view their work schedule.

10. The method of claim 1 wherein said human resource units can review general bulletins for the area.

11. The method of claim 1 wherein said human resource units can view and respond to mail from the manager on duty.

12. The method of claim 1 wherein said human resource units can select, confirm, and receive their position assignments.

13. A method for the real time deployment of a plurality of individual human resource units by character and need, the method comprising the steps of:
a) maintaining a network having a central database and processor including a plurality of input locations dispersed at recognized work sites and further including individual resource unit characteristics and diverse work location requirements;
b) requiring each human resource to register with at least one of said input locations;
c) generating an activity queue assigning said registered resource units by availability and characteristics to respective ones of said diverse work locations requiring said resource unit having said characteristics for a specific time period providing manager with said data;
d) revising said activity queue to correspond with current human resources and needs.

14. The method of claim 13 further comprising the step of importing data from a scheduling application.

15. The method of claim 13 further requiring the step of requiring each human resource unit to check in with one of said input locations at pre-determined times throughout the day.

16. The method of claim 13 further comprising the step of notifying said human resources units of changes said activity queue when they occur.

17. A method for the real time deployment of a plurality of individual human resource units by character and need in an entertainment center including amusements, stores, concessions, food and maintenance areas, the method comprising the steps of:
d) maintaining a computer network dispersed throughout a diverse work area, the computer network having a central database and processor and a plurality of input devices at remote locations relevant to this diverse work area;
e) requiring at least one said human resource unit to log in to at least one of the plurality of said input devices; and
f) using the central processor to process input from said human resources units into said remote locations to generate a real time queue for actively deploying respective ones of said plurality of human resource units by matching character of said human resource units with need of the work area which may be one of the following: stores, concessions, food, or maintenance.

18. The method of claim 17 wherein matching character of said human resource units with need of the work area involves matching the skills of said human resource unit with the tasks required to be completed at the work area.

19. The method of claim 17 wherein matching character of said human resource units with need of the work area involves assigning the task of highest priority at the time to the next available human resource unit with the proper skill level to perform the task.

20. A method of deploying employees to an operating area in real time, the method comprising the steps of:
receiving forecasting and scheduling information;
automatically assigning breaks, lunches, and tasks
tracking the positions of employees in said operating area; and
making recommendations on future assignments based on priorities that are predetermined by managers.

21. A system for the real time deployment of a plurality of individual human resource units by character and need, comprising at least one central processor with the capacity to manipulate data at least one central database coupled to said central processor for storing information, a plurality of input devices at remote locations for users to interact with, and a computer network connecting said processor and database to said input devices.
